(19) United States
(12) Patent Application Publication
(10) Pub. No.: US 2005/0076015 A1
(43) Pub. Date: Apr. 7, 2005

(54) Dynamic query building based on the desired number of results

(75) Inventors: Richard D. Dettinger, Rochester, MN (US); Frederick A. Kulack, Rochester, MN (US); Richard J. Stevens, Mantorville, MN (US); Eric W. Will, Oronoco, MN (US)

Correspondence Address: William J. McGinnis, Jr.;IBM Corporation, Dept. 917, 3605 Highway 52 North, Rochester, MN, 55901-7829, US

(73) Assignee: INTERNATIONAL BUSINESS MACHINES CORPORATION, ARMONK, NY (US)

(21) Appl. No.: 10/677,472

(22) Filed: Oct. 2, 2003

(51) Int. Cl. G06F 7/00

(52) U.S. Cl. 707/3

(57) ABSTRACT

Methods, apparatus and article of manufacture for modifying query elements to produce a desired result size. A requesting entity specifies a desired result set size to be returned for a given query. One or more elements specified in the query are modified until a resulting modified query is produced which, when executed produces the desired result set size.

### CROSS-RELATED APPLICATIONS

This application is related to commonly owned U.S. patent application Ser. No. 10/131,984, entitled “REMOTE DATA ACCESS AND INTEGRATION OF DISTRIBUTED DATA SOURCES THROUGH DATA SCHEMA AND QUERY ABSTRACTION” and U.S. patent application Ser. No. 10/094,531, entitled “GRAPHICAL USER INTERFACE TO BUILD EVENT-BASED DYNAMIC SEARCHES OR QUERIES USING EVENT PROFILES”, incorporated herein by reference.

### BACKGROUND OF THE INVENTION

1. Field of the Invention

The present invention generally relates to data processing, and more particularly, to the accessing data through a logical framework.

2. Description of the Related Art

Databases are computerized information storage and retrieval systems. The most prevalent type of database is the relational database, a tabular database in which data is defined so that it can be reorganized and accessed in a number of different ways. A relational database management system (DBMS) is a database management system that uses relational techniques for storing and retrieving data.

Regardless of the particular architecture, in a DBMS, a requesting entity (e.g., an application, the operating system or a user) demands access to a specified database by issuing a database access request. Such requests may include, for instance, simple catalog lookup requests or transactions and combinations of transactions that operate to read, change and add specified records in the database. These requests are made using high-level query languages such as the Structured Query Language (SQL). Illustratively, SQL is used to make interactive queries for getting information from and updating a database such as International Business Machines' (IBM) DB2, Microsoft's SQL Server, and database products from Oracle, Sybase, and Computer Associates. The term “query” denominates a set of commands for retrieving data from a stored database. Queries take the form of a command language that lets programmers and programs select, insert, update, find out the location of data, and so forth.

Often times a query is only meaningful when the results of the query have a certain size. For example, in finding candidates for a clinical trial, the number of people in the result set should not be in the range of 1-5, and likely should not be in excess of 1000 either. As a result, particularly in research-oriented environments, the task of finding suitable results to a query is typically a multi-step, iterative process involving generation of an initial set of query results, analysis of initial set of query results, and comparison of the initial set of query results with other available information to yield another set of data results. This time-consuming process continues until the user is satisfied with the number of results returned.

Besides the above-described trial and error method, some searching algorithms exist to provide various degrees of result set management. For example, one algorithm returns the first N results. If the query returns more than N results, the excess number of results is discarded. If the query returns less than N results, only those results are displayed. Accordingly, this algorithm does not address the situation described above in which the user is interested in crafting a query that returns a desired number of results.

Other algorithms, notably text search engines, will return the results in a ranked order. With accurate ranking, the first N results may have some correlation. But the user is not guaranteed of any correlation and has no way of identifying or controlling the basis of the correlation.

Data text mining examines information to find significant relationships between pieces of data and can be focused to look at a given area. However, this approach does not have the results size factored into its algorithms.

Therefore, what is needed is an apparatus, method and article of manufacture for managing results returned by query.

### SUMMARY OF THE INVENTION

The present invention provides a method, system and article of manufacture for managing results returned by query. More particularly, query elements are modified to produce a desired result size. A requesting entity specifies a desired result set size to be returned for a given query. One or more elements specified in the query are modified until a resulting modified query is produced which, when executed produces the desired result set size.

In one embodiment, result management is implemented through an abstraction model. The abstraction model includes metadata describing and defining a plurality of logical fields. One or more of the logical field definitions in the abstract model include attributes indicating that a value specified for the logical field can be modified in order to produce a different result set for a given query.

One embodiment provides a computer-implemented method of using a logical model to query physical fields of physical data entities. The method comprises providing a logical model to logically describe the physical fields, the logical model comprising logical fields corresponding to respective physical fields; and providing a runtime component configured to change at least one element of an abstract query in an attempt to produce a modified abstract query which, when executed, returns results satisfying a result set criterion; wherein the abstract query is defined with respect to at least one logical field of the logical model and wherein at least one value is specified for the at least one logical field.

Another embodiment provides a computer-implemented method of returning a desired result set for a query. The method comprises providing a logical model to logically describe physical fields of physical data entities, the logical model comprising logical fields corresponding to respective physical fields and each having an associated modification parameter; receiving an abstract query comprising a result set criterion and a specified value for at least one of the logical fields of the logical model; and manipulating the abstract query in an attempt to produce a modified abstract query which, when executed, returns results satisfying the result set criterion; wherein the manipulating is, at least in part, defined by the associated modification parameter of the at least one of the logical fields of the logical model.

Yet another embodiment of a computer-implemented method of building queries comprises providing a logical model to logically describe physical fields of a plurality of physical data entities, the logical model comprising logical fields corresponding to respective physical fields; receiving an abstract query defined with respect to at least one logical field of the logical model and comprising a user-specified value for the at least one logical field and a result set criterion specifying at least a size of a desired result set; and programmatically manipulating the abstract query in an attempt to produce a modified abstract query which, when executed, returns results satisfying the result set criterion.

Yet another embodiment provides a computer-implemented method for returning a specified result size set for a query. The method comprises receiving a query comprising at least one condition and an associated value for the condition and a user-specified results criterion; changing a first element of the abstract query to produce a modified query; running the modified query to produce a result set; if the result set does not satisfy the user-specified results criterion, changing either (or both of) the first element and a second element of the associated condition to produce a different modified query; and running the different modified query to produce a different result set.

Still another embodiment provides a computer readable medium containing a program which, when executed, performs an operation with respect to abstract queries and a logical model comprising a plurality of logical field definitions mapping to physical fields of physical entities of the data. The operation comprises receiving an abstract query defined with respect to at least one logical field of the logical model and comprising (i) a user-specified value for the at least one logical field and (ii) a result set criterion specifying at least a size of a desired result set; and manipulating abstract query in an attempt to produce a modified abstract query which, when executed, returns results satisfying the result set criterion.

Still another embodiment provides a computer system, comprising memory and at least one processor, and further comprising a logical model comprising a plurality of logical field definitions mapping to physical fields of physical entities of data, whereby the logical model provides a logical view of the data; and a runtime component. The runtime component is configured to at least (i) receive an abstract query comprising at least one condition with a reference to at least one of the logical field definitions, a value for the at least one logical field and at least one user-selected result size criterion specifying a desired result set size to be returned; and (ii) change an element of the abstract query in an effort to satisfy the result size criterion.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a block diagram of an illustrative computer architecture.

FIG. 2 is a relational view of software components of one embodiment of the invention configured to process queries against a physical data source through an abstract representation of the physical data source.

FIG. 3 is a flow chart illustrating the operation of a runtime component.

FIG. 4 is a flow chart illustrating the operation of a runtime component.

FIG. 5 is a flowchart illustrating the operation of a runtime component to produce a query satisfying result criteria.

FIG. 6 is a flowchart illustrating the operation of a runtime component to produce a query satisfying result criteria.

FIG. 7 is a flowchart illustrating the operation of a runtime component to produce a query satisfying result criteria.

### DETAILED DESCRIPTION OF THE PREFERRED EMBODIMENTS

Introduction

One embodiment of the invention is implemented as a program product for use with a computer system and described below. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The software of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular nomenclature that follows is used merely for convenience, and thus the invention should not be limited to use solely in any specific application identified and/or implied by such nomenclature.

Embodiments of the invention provide for dynamic query building based on a result set criteria (e.g., a number of results or a range of results). A given query is manipulated until the query satisfies the result set criteria. The query can then be run, after which results are returned.

In one embodiment, a particular data definition framework, also referred to herein as a data abstraction model (DAM), is provided for querying data independent of the particular manner in which the data is physically represented. The DAM includes metadata describing and defining a plurality of logical fields which map to physical data. Metadata is also provided to describe, for example, the types of permitted query modifications that can be made in an effort to craft a modified query which satisfies the result set criteria. However, although embodiments of the invention are described with respect to queries built and executed with respect to a logical model, the invention is not so limited. Accordingly, embodiments in which queries are crafted by users in conventional manners (e.g., using SQL) are specifically contemplated and are within the scope of the invention.

Physical View of Environment

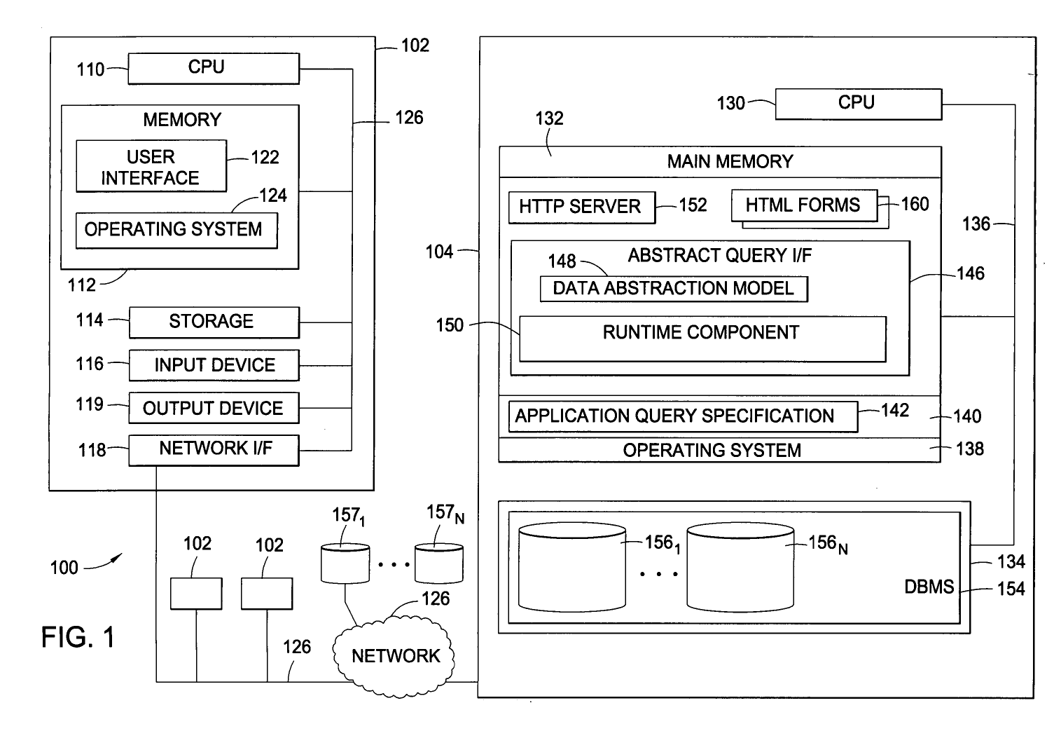

FIG. 1 depicts a block diagram of a networked system 100 in which embodiments of the present invention may be implemented. In general, the networked system 100 includes a client (i.e., generally any requesting entity such as a user or application) computer 102 (three such client computers 102 are shown) and at least one server computer 104 (one such server computer 104 is shown). The client computer 102 and the server computer 104 are connected via a network 126. In general, the network 126 may be a local area network (LAN) and/or a wide area network (WAN). In a particular embodiment, the network 126 is the Internet. However, it is noted that aspects of the invention need not be implemented in a distributed environment. As such, the client computers 102 and the server computer 104 are more generally representative of any requesting entity (such as a user or application) issuing queries and a receiving entity configured to handle the queries, respectively.

The client computer 102 includes a Central Processing Unit (CPU) 110 connected via a bus 130 to a memory 112, storage 114, an input device 116, an output device 119, and a network interface device 118. The input device 116 can be any device to give input to the client computer 102. For example, a keyboard, keypad, light-pen, touch-screen, track-ball, or speech recognition unit, audio/video player, and the like could be used. The output device 119 can be any device to give output to the user, e.g., any conventional display screen. Although shown separately from the input device 116, the output device 119 and input device 116 could be combined. For example, a display screen with an integrated touch-screen, a display with an integrated keyboard, or a speech recognition unit combined with a text speech converter could be used.

The network interface device 118 may be any entry/exit device configured to allow network communications between the client computer 102 and the server computer 104 via the network 126. For example, the network interface device 118 may be a network adapter or other network interface card (NIC).

Storage 114 is preferably a Direct Access Storage Device (DASD). Although it is shown as a single unit, it could be a combination of fixed and/or removable storage devices, such as fixed disc drives, floppy disc drives, tape drives, removable memory cards, or optical storage. The memory 112 and storage 114 could be part of one virtual address space spanning multiple primary and secondary storage devices.

The memory 112 is preferably a random access memory sufficiently large to hold the necessary programming and data structures of the invention. While the memory 112 is shown as a single entity, it should be understood that the memory 112 may in fact comprise a plurality of modules, and that the memory 112 may exist at multiple levels, from high speed registers and caches to lower speed but larger DAMM chips.

Illustratively, the memory 112 contains an operating system 124. Illustrative operating systems, which may be used to advantage, include Linux and Microsoft's Windows®. More generally, any operating system supporting the functions disclosed herein may be used.

The memory 112 is also shown containing a user interface 122 that, when executed on CPU 110, provides support for building queries. In one embodiment, the user interface 122 includes a web-based Graphical User Interface (GUI), which allows the user to display Hyper Text Markup Language (HTML) information. More generally, however, the user interface 122 may be any GUI-based program capable of rendering elements (e.g., fields, menus, buttons) necessary to build queries.

The server computer 104 may be physically arranged in a manner similar to the client computer 102. Accordingly, the server computer 104 is shown generally comprising a CPU 130, a memory 132, and a storage device 134, coupled to one another by a bus 136. Memory 132 may be a random access memory sufficiently large to hold the necessary programming and data structures that are located on the server computer 104.

The server computer 104 is generally under the control of an operating system 138 shown residing in memory 132. Examples of the operating system 138 include IBM OS/400®, UNIX, Microsoft Windows®, and the like. More generally, any operating system capable of supporting the functions described herein may be used.

The memory 132 further includes one or more applications 140 and an abstract query interface 146. The applications 140 and the abstract query interface 146 are software products comprising a plurality of instructions that are resident at various times in various memory and storage devices in the computer system 100. When read and executed by one or more processors 130 in the server 104, the applications 140 and the abstract query interface 146 cause the computer system 100 to perform the steps necessary to execute steps or elements embodying the various aspects of the invention. The applications 140 (and more generally, any requesting entity, including the operating system 138 and, at the highest level, users) issue queries against a database. Illustrative sources against which queries may be issued include local databases 156₁ . . . 156_{N}, and remote databases 157₁ . . . 157_{N}, collectively referred to as database(s) 156-157). Illustratively, the databases 156 are shown as part of a database management system (DBMS) 154 in storage 134. More generally, as used herein, the term “databases” refers to any collection of data regardless of the particular physical representation. By way of illustration, the databases 156-157 may be organized according to a relational schema (accessible by SQL queries) or according to an XML schema (accessible by XML queries). However, the invention is not limited to a particular schema and contemplates extension to schemas presently unknown. As used herein, the term “schema” generically refers to a particular arrangement of data which is described by a data repository abstraction 148.

In one embodiment, the queries issued by the applications 140 are defined according to an application query specification 142 included with each application 140. The queries issued by the applications 140 may be predefined (i.e., hard coded as part of the applications 140) or may be generated in response to input (e.g., user input). In either case, the queries (referred to herein as “abstract queries”) are composed using logical fields defined by the abstract query interface 146. In particular, the logical fields used in the abstract queries are defined by the data abstraction model (DAM) 148 of the abstract query interface 146. The abstract queries are processed by a runtime component 150 which transforms the abstract queries into a form (referred to herein as a concrete query) consistent with the physical representation of the data contained in one or more of the databases 156-157. In one embodiment, the run-time component 150 includes analysis tool 162. In general, the analysis tool 162 itself includes a query modification algorithm and provides users with additional flexibility and control over the number of results returned. Each of the components/functions of the abstract query interface 146 is further described below.

The abstract queries processed by the runtime component 150 may be configured to access the data and return results, or to modify (i.e., insert, delete or update) the data. In one embodiment, elements of a query are specified by a user through a graphical user interface (GUI). The content of the GUIs is generated by the application(s) 140. In a particular embodiment, the GUI content is hypertext markup language (HTML) content which may be rendered on the client computer systems 102 with the user interface 122. Accordingly, the memory 132 includes a Hypertext Transfer Protocol (http) server process 138 (e.g., a web server) adapted to service requests from the client computer 102. For example, the process 138 may respond to requests to access a database(s) 156, which illustratively resides on the server 104. Incoming client requests for data from a database 156-157 invoke an application 140. When executed by the processor 130, the application 140 causes the server computer 104 to perform the steps or elements embodying the various aspects of the invention, including accessing the database(s) 156-157. In one embodiment, the application 140 comprises a plurality of servlets configured to build GUI elements, which are then rendered by the user interface 122. Where the remote databases 157 are accessed via the application 140, the data abstraction model 148 is configured with a location specification identifying the database containing the data to be retrieved. This latter embodiment will be described in more detail below.

FIG. 1 is merely one hardware/software configuration for the networked client computer 102 and server computer 104. Embodiments of the present invention can apply to any comparable hardware configuration, regardless of whether the computer systems are complicated, multi-user computing apparatus, single-user workstations, or network appliances that do not have non-volatile storage of their own. Further, it is understood that while reference is made to particular markup languages, including HTML, the invention is not limited to a particular language, standard or version. Accordingly, persons skilled in the art will recognize that the invention is adaptable to other markup languages as well as non-markup languages and that the invention is also adaptable future changes in a particular markup language as well as to other languages presently unknown. Likewise, the http server process 138 shown in FIG. 1 is merely illustrative and other embodiments adapted to support any known and unknown protocols are contemplated.

Logical/Runtime View of Environment

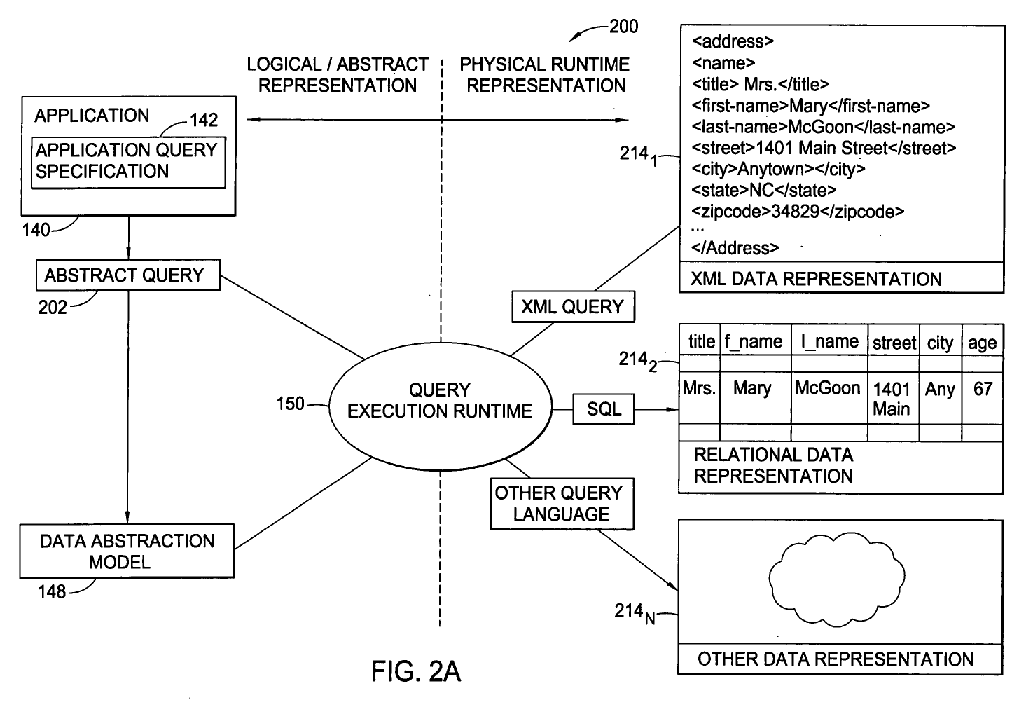

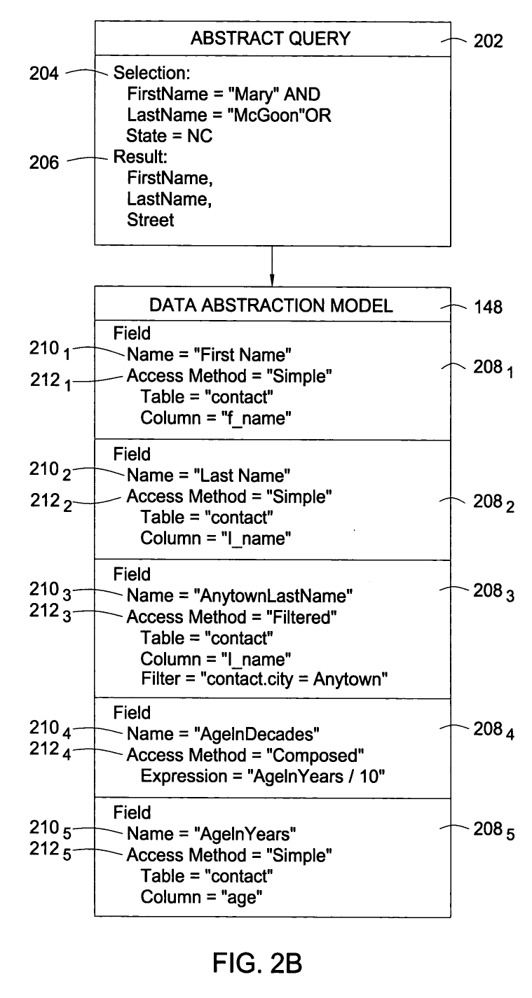

FIGS. 2A-B show a plurality of interrelated components of the invention. The requesting entity (e.g., one of the applications 140) issues a query 202 as defined by the respective application query specification 142 of the requesting entity. The resulting query 202 is generally referred to herein as an “abstract query” because the query is composed according to abstract (i.e., logical) fields rather than by direct reference to the underlying physical data entities in the databases 156-157. As a result, abstract queries may be defined that are independent of the particular underlying data representation used. In one embodiment, the application query specification 142 may include both criteria used for data selection (selection criteria 204) and an explicit specification of the fields to be returned (return data specification 206) based on the selection criteria 204.

The logical fields specified by the application query specification 142 and used to compose the abstract query 202 are defined by the data abstraction model 148. In general, the data abstraction model 148 exposes information as a set of logical fields that may be used within a query (e.g., the abstract query 202) issued by the application 140 to specify criteria for data selection and specify the form of result data returned from a query operation. The logical fields are defined independently of the underlying data representation being used in the databases 156-157, thereby allowing queries to be formed that are loosely coupled to the underlying data representation. The data to which logical fields of the DAM 148 are mapped may be located in a single repository (i.e., source) of data or a plurality of different data repositories. Thus, the DAM 148 may provide a logical view of one or more underlying data repositories. By using an abstract representation of a data repository, the underlying physical representation can be more easily changed or replaced without affecting the application making the changes. Instead, the abstract representation is changed with no changes required by the application. In addition, multiple abstract data representations can be defined to support different applications against the same underlying database schema that may have different default values or required fields.

In general, the data abstraction model 148 comprises a plurality of field specifications 208₁, 208₂, 208₃, 208₄ and 208₅ (five shown by way of example), collectively referred to as the field specifications 208. Specifically, a field specification is provided for each logical field available for composition of an abstract query. Each field specification comprises a logical field name 210₁, 210₂, 210₃, 210₄, 210₅ (collectively, field name 210) and an associated access method 212₁, 212₂, 212₃, 212₄, 212₅ (collectively, access method 212). The access methods associate (i.e., map) the logical field names to a particular physical data representation 214₁, 214₂ . . . 214_{N} in a database (e.g., one of the databases 156) according to parameters referred to herein as physical location parameters. By way of illustration, two data representations are shown, an XML data representation 214₁ and a relational data representation 214₂. However, the physical data representation 214_{N} indicates that any other data representation, known or unknown, is contemplated.

Any number of access methods are contemplated depending upon the number of different types of logical fields to be supported. In one embodiment, access methods for simple fields, filtered fields and composed fields are provided. The field specifications 208₁, 208₂ and 208₅ exemplify simple field access methods 212₁, 212₂, and 212₅, respectively. Simple fields are mapped directly to a particular entity in the underlying physical data representation (e.g., a field mapped to a given database table and column). By way of illustration, the simple field access method 212₁ shown in FIG. 2B maps the logical field name 210₁ (“FirstName”) to a column named “f_name” in a table named “contact”, where the table name and the column name are the physical location parameters of the access method 212₁. The field specification 208₃ exemplifies a filtered field access method 212₃. Filtered fields identify an associated physical entity and provide rules used to define a particular subset of items within the physical data representation. An example is provided in FIG. 2B in which the filtered field access method 212₃ maps the logical field name 210₃ (“AnytownLastName”) to a physical entity in a column named “I_name” in a table named “contact” and defines a filter for individuals in the city of Anytown. Another example of a filtered field is a New York ZIP code field that maps to the physical representation of ZIP codes and restricts the data only to those ZIP codes defined for the state of New York. The field specification 208₄ exemplifies a composed field access method 212₄. Composed access methods compute a logical field from one or more physical fields using an expression supplied as part of the access method definition. In this way, information which does not exist in the underlying data representation may computed. In the example illustrated in FIG. 2B the composed field access method 212₃ maps the logical field name 210₃ “AgeInDecades” to “AgeInYears/10”. Another example is a sales tax field that is composed by multiplying a sales price field by a sales tax rate.

It is noted that the data abstraction model 148 shown in FIG. 2B is merely illustrative of selected logical field specifications and is not intended to be comprehensive. As such, the abstract query 202 shown in FIG. 2B includes some logical fields for which specifications are not shown in the data abstraction model 148, such as “State” and “Street”.

It is contemplated that the formats for any given data type (e.g., dates, decimal numbers, etc.) of the underlying data may vary. Accordingly, in one embodiment, the field specifications 208 include a type attribute which reflects the format of the underlying data. However, in another embodiment, the data format of the field specifications 208 is different from the associated underlying physical data, in which case an access method is responsible for returning data in the proper format assumed by the requesting entity. Thus, the access method must know what format of data is assumed (i.e., according to the logical field) as well as the actual format of the underlying physical data. The access method can then convert the underlying physical data into the format of the logical field.

By way of example, the field specifications 208 of the data abstraction model 148 shown in FIG. 2A are representative of logical fields mapped to data represented in the relational data representation 214₂. However, other instances of the data abstraction model 148 map logical fields to other physical data representations, such as XML. Further, in one embodiment, a data abstraction model 148 is configured with access methods for procedural data representations.

An illustrative abstract query corresponding to the abstract query 202 shown in FIG. 2 is shown in Table I below. By way of illustration, the data repository abstraction 148 is defined using XML. However, any other language may be used to advantage.

TABLE I
QUERY EXAMPLE

001 <?xml version=“1.0”?>
002 <!--Query string representation: (FirstName = “Mary” AND LastName =
003 “McGoon”) OR State = “NC”-->
004 <QueryAbstraction>
005 <Selection>
006 <Condition internalID=“4”>
007 <Condition field=“FirstName” operator=“EQ” value=“Mary”
008 internalID=“1”/>
009 <Condition field=“LastName” operator=“EQ” value=“McGoon”
010 internalID=“3” relOperator=“AND”></Condition>
011 </Condition>
012 <Condition field=“State” operator=“EQ” value=“NC” internalID=“2”
013 relOperator=“OR”></Condition>
014 </Selection>
015 <Results>
016 <Field name=“FirstName”/>
017 <Field name=“LastName”/>
018 <Field name=“State”/>
019 </Results>
020 </QueryAbstraction>

Illustratively, the abstract query shown in Table I includes a selection specification (lines 005-014) containing selection criteria and a results specification (lines 015-019). In one embodiment, a selection criterion consists of a field name (for a logical field), a comparison operator (=, >, <, etc) and a value expression (what is the field being compared to). In one embodiment, result specification is a list of abstract fields that are to be returned as a result of query execution. A result specification in the abstract query may consist of a field name and sort criteria. The individual elements of the selection criteria (i.e., the selection criterions) and the results specification may be referred to as query conditions. Thus, “FirstName=Mary” is a query condition in which the logical field, “FirstName”, has the value “Mary”.

An illustrative instance of a data abstraction model 148 corresponding to the abstract query in Table I is shown in Table II below. By way of illustration, the data abstraction model 148 is defined using XML. However, any other language may be used to advantage.

TABLE II
DATA ABSTRACTION MODEL EXAMPLE

001 <?xml version=“1.0”?>
002 <DataRepository>
003 <Category name=“Demographic”>
004 <Field queryable=“Yes” name=“FirstName” displayable=“Yes”>
005 <AccessMethod>
006 <Simple columnName=“f_name” tableName=“contact”></Simple>
007 </AccessMethod>
008 <Type baseType=“char”></Type>
009 </Field>
010 <Field queryable=“Yes” name=“LastName” displayable=“Yes”>
011 <AccessMethod>
012 <Simple columnName=“l_name” tableName=“contact”></Simple>
013 </AccessMethod>
014 <Type baseType=“char”></Type>
015 </Field>
016 <Field queryable=“Yes” name=“State” displayable=“Yes”>
017 <AccessMethod>
018 <Simple columnName=“state” tableName=“contact”></Simple>
019 </AccessMethod>
020 <Type baseType=“char”></Type>
021 </Field>
022 </Category>
023 </DataRepository>

Note that lines 004-009 correspond to the first field specification 208₁ of the DAM 148 shown in FIG. 2B and lines 010-015 correspond to the second field specification 208₂. For brevity, the other field specifications defined in Table I have not been shown in FIG. 2B. Note also that Table I illustrates a category, in this case “Demographic”. A category is a grouping of one or more logical fields. In the present example, “First Name”, “Last Name” and “State” are logical fields belonging to the common category, “Demographic”.

In any case, a data abstraction model 148 contains (or refers to) at least one access method that maps a logical field to physical data. However, the foregoing embodiments are merely illustrative and the logical field specifications may include a variety of other metadata. In one embodiment, the access methods are further configured with a location specification defining a location of the data associated with the logical field. In this way, the data abstraction model 148 is extended to include description of a multiplicity of data sources that can be local and/or distributed across a network environment. The data sources can be using a multitude of different data representations and data access techniques. In this manner, an infrastructure is provided which is capable of capitalizing on the distributed environments prevalent today. One approach for accessing a multiplicity of data sources is described in more detail in U.S. patent application Ser. No. 10/131,984, entitled “REMOTE DATA ACCESS AND INTEGRATION OF DISTRIBUTED DATA SOURCES THROUGH DATA SCHEMA AND QUERY ABSTRACTION” and assigned to International Business Machines, Inc.

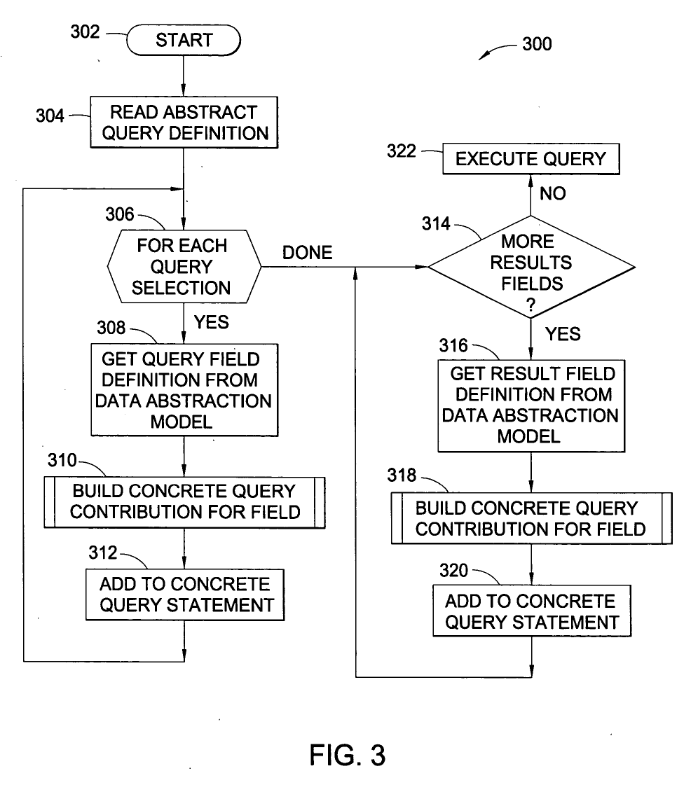

FIG. 3 shows an illustrative runtime method 300 exemplifying one embodiment of the operation of the runtime component 150. The method 300 is entered at step 302 when the runtime component 150 receives as input an instance of an abstract query (such as the abstract query 202 shown in FIG. 2). At step 304, the runtime component 150 reads and parses the instance of the abstract query and locates individual selection criteria and desired result fields. At step 306, the runtime component 150 enters a loop (comprising steps 306, 308, 310 and 312) for processing each query selection criteria statement present in the abstract query, thereby building a data selection portion of a Concrete Query. In one embodiment, a selection criterion consists of a field name (for a logical field), a comparison operator (=, >, <, etc) and a value expression (what is the field being compared to). At step 308, the runtime component 150 uses the field name from a selection criterion of the abstract query to look up the definition of the field in the data repository abstraction 148. As noted above, the field definition includes a definition of the access method used to access the physical data associated with the field. The runtime component 150 then builds (step 310) a Concrete Query Contribution for the logical field being processed. As defined herein, a Concrete Query Contribution is a portion of a concrete query that is used to perform data selection based on the current logical field. A concrete query is a query represented in languages like SQL and XML Query and is consistent with the data of a given physical data repository (e.g., a relational database or XML repository).

Accordingly, the concrete query is used to locate and retrieve data from a physical data repository, represented by the databases 156-157 shown in FIG. 1. The Concrete Query Contribution generated for the current field is then added to a Concrete Query Statement. The method 300 then returns to step 306 to begin processing for the next field of the abstract query. Accordingly, the process entered at step 306 is iterated for each data selection field in the abstract query, thereby contributing additional content to the eventual query to be performed.

After building the data selection portion of the concrete query, the runtime component 150 identifies the information to be returned as a result of query execution. As described above, in one embodiment, the abstract query defines a list of abstract fields that are to be returned as a result of query execution, referred to herein as a result specification. A result specification in the abstract query may consist of a field name and sort criteria. Accordingly, the method 300 enters a loop at step 314 (defined by steps 314, 316, 318 and 320) to add result field definitions to the concrete query being generated. At step 316, the runtime component 150 looks up a result field name (from the result specification of the abstract query) in the data repository abstraction 148 and then retrieves a Result Field Definition from the data repository abstraction 148 to identify the physical location of data to be returned for the current logical result field. The runtime component 150 then builds (as step 318) a Concrete Query Contribution (of the concrete query that identifies physical location of data to be returned) for the logical result field. At step 320, Concrete Query Contribution is then added to the Concrete Query Statement. Once each of the result specifications in the abstract query has been processed, the query is executed at step 322.

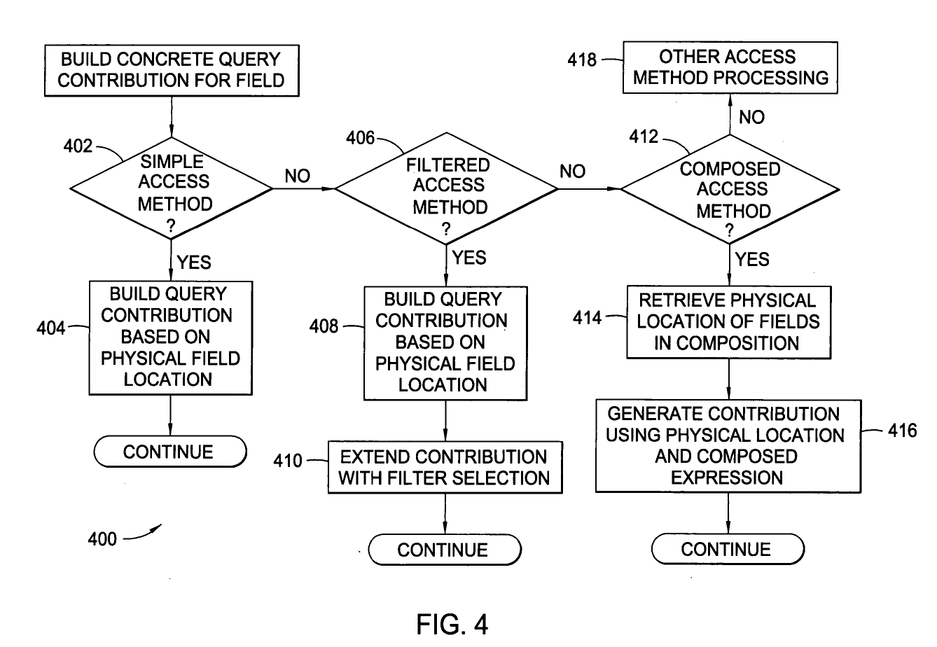

One embodiment of a method 400 for building a Concrete Query Contribution for a logical field according to steps 310 and 318 is described with reference to FIG. 4. At step 402, the method 400 queries whether the access method associated with the current logical field is a simple access method. If so, the Concrete Query Contribution is built (step 404) based on physical data location information and processing then continues according to method 300 described above. Otherwise, processing continues to step 406 to query whether the access method associated with the current logical field is a filtered access method. If so, the Concrete Query Contribution is built (step 408) based on physical data location information for some physical data entity. At step 410, the Concrete Query Contribution is extended with additional logic (filter selection) used to subset data associated with the physical data entity. Processing then continues according to method 300 described above.

If the access method is not a filtered access method, processing proceeds from step 406 to step 412 where the method 400 queries whether the access method is a composed access method. If the access method is a composed access method, the physical data location for each sub-field reference in the composed field expression is located and retrieved at step 414. At step 416, the physical field location information of the composed field expression is substituted for the logical field references of the composed field expression, whereby the Concrete Query Contribution is generated. Processing then continues according to method 300 described above.

If the access method is not a composed access method, processing proceeds from step 412 to step 418. Step 418 is representative of any other access methods types contemplated as embodiments of the present invention. However, it should be understood that embodiments are contemplated in which less then all the available access methods are implemented. For example, in a particular embodiment only simple access methods are used. In another embodiment, only simple access methods and filtered access methods are used.

As described above, it may be necessary to perform a data conversion if a logical field specifies a data format different from the underlying physical data. In one embodiment, an initial conversion is performed for each respective access method when building a Concrete Query Contribution for a logical field according to the method 400. For example, the conversion may be performed as part of, or immediately following, the steps 404, 408 and 416. A subsequent conversion from the format of the physical data to the format of the logical field is performed after the query is executed at step 322. Of course, if the format of the logical field definition is the same as the underlying physical data, no conversion is necessary.

Query Result Managment

In one embodiment, the user (or other entity) is given the flexibility to dictate the number of results returned for a given abstract query. More particularly, the number of results returned is controlled by modification of one or more elements of a query. This may be accomplished, for example, by configuring the logical field specifications of the data abstraction model 148 with attributes directed to the modification of an initial query containing the logical field specification. Illustrative embodiments would include attributes of a logical field specification which modify the values of a query condition corresponding to the logical field specification, or which remove the condition from the query altogether. Consider, for example, the portion of a data abstraction model shown in the following Table III.

TABLE III
DATA ABSTRACTION MODEL EXAMPLE

001 <Field queryable=“Yes” name=“Clinic Number” displayable=“Yes” >
002 <Type baseType=“char”></Type>
003 </Field>
004 <Field queryable=“Yes” name=“Postal Code” displayable=“Yes”
005 expandable=“Yes” >
006 <AccessMethod>
007 <Simple attrName=“POSTAL_CDE” EntityName=“ADDR”></Simple>
008 </AccessMethod>
009 <ExpansionMethod>
010 <Api class=DB2SpatialExtender.java parm1=char, parm2=int >
011 </ExpansionMethod>
012 <Type baseType=“char”></Type>
013 </Field>
014 <Field queryable=“Yes” name=“Gender” displayable=“Yes” expandable=“Yes” >
015 <AccessMethod>
016 <Simple attrName=“GENDER_CDE” entityName=“DEMO”></Simple>
017 </AccessMethod>
018 <Type baseType=“char”>
019 <List>
020 <Value val=“Female” actualVal=“F” />
021 <Value val=“Male” actualVal=“M” />
022 <Value val=“Unknown” actualVal=“U” />
023 </List>
024 </Type>
025 <Description></Description>
026 </Field>
027 <Field queryable=“Yes” name=“Result” displayable=“Yes” expandable=“Yes” >
028 <Type baseType=“float”> </Type>
029 </Field>

The data abstraction model of TABLE III illustrates three logical field specifications having an attribute which enables query condition modifications. The three logical field specifications are Postal Code (at lines 003-013), Gender (at lines 014-026) and Result (at lines 027-029). In each case, the attribute is given as “expandable=“Yes” ”, as shown at lines 005, 014, and 027, respectively. The presence of such an attribute for a given logical field specification indicates that a query containing a corresponding logical field may modified. In this particular example, the logical fields are modified by manipulating the value of the logical field and each of the logical field specifications are representative of different types of value modifications that can be made. For example, the logical field specification for “Postal Code” represents a field having a set of related values. In this case, a given postal code could be extended to include a broader geographic area (e.g., described in terms of miles). In one embodiment, the postal code expansion is accomplished through an external API. In the present example this is provided by a DB2 (a product of International Business Machines, Inc.) spatial extender which allows all ZIP codes within a certain mileage radius to be returned. The logical field specification for “Gender” represents a field having a set of mutually exclusive defined values (i.e., male, female and unknown). For a query which specifies only one of the mutually exclusive values, value modification is the inclusion of one of the other values, or the removal of the condition altogether (in which case the query will return results for each of the possible values). The logical field specification for “Result” represents a field with numerical values. In this case, modification may be defined as a range of values, a number of standard deviations or something defined via an external API.

It is to be understood that the foregoing data abstraction model (shown in Table 111) is merely illustrative. Other logical field specifications may also be modified. Further, as is evident from the example in Table III, the attribute name, “expandable” is arbitrary and not intended to suggest that the corresponding value is necessarily modified strictly by expansion. Accordingly, while “expansion” may be repeatedly referred to herein with respect to modifying a query element (e.g., changing a value and/or condition), such reference is for convenience of illustration only and does not limit embodiments of the invention to expansion. As such, embodiments described with respect to expansion may also be implemented with other types of modification. Other illustrative value modifications include value restriction, value truncation, statistical determination of values, etc. In this regard it is noted that “value” as defined herein includes numerical values as well as non-numerical values. Thus, as noted above, “Result” represents a field with numerical values and “Gender” represents a field having a set of mutually exclusive defined non-numerical values, i.e., male, female and unknown. Still further, it is contemplated that a given query condition having a defined value may be removed altogether from a query. In this regard it was noted above (with respect to the “Gender” field) that in some cases changing the value for a condition has the same effect as removing the original condition. Consider, for example, a query having “Gender=Male” as a condition. Changing the value of the condition to “Female” effectively removes the condition “Gender=Male”. It is evident therefore, that a variety of techniques for query manipulation types is contemplated. Accordingly, in a more general sense, aspects of the invention may be described with respect to modifications (which includes removal) of query elements to achieve a desired number of results. By way of definition, the term “query element” refers to any aspect/constituent of a query. Thus, an element may be a value, a condition, an operator or any other aspect of a query which may be affected to change the number of results returned by a query. Thus, while the embodiments herein may describe modifications of values and/or conditions, it is understood that such embodiments are merely illustrative and, more generally, any modification of query elements is contemplated.

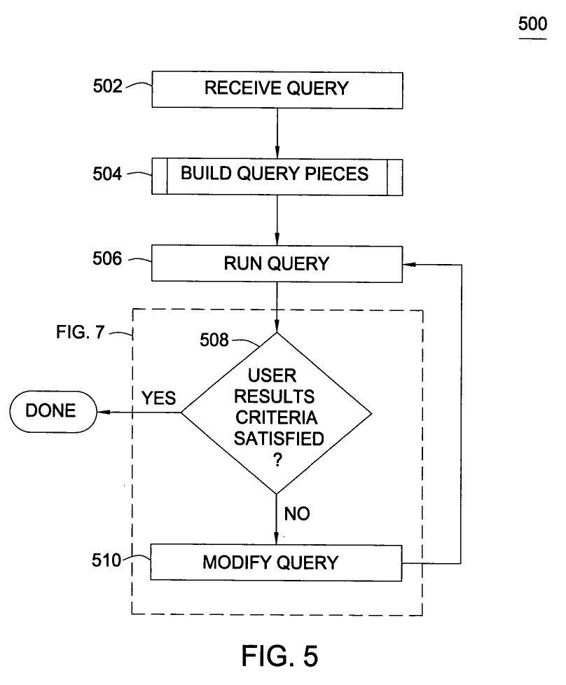

Additional aspects of the invention will now be described with reference to FIGS. 5-7. By way of illustration only, these aspects will be described with reference to the following abstract query:
<DesiredResultSize: Min=100 Max=500>Gender=“Female”<expansion:No>AND Result>100<expansion:Yes ExpansionLevel=30>AND PostalCode=‘55901’<expansion:Yes ExpansionLevel=50>

In this example, the user desires a minimum number of results of 100 and a maximum number of 500. Each condition of the query containing a modifiable logical field (i.e., a logical field having the “expand” attribute set to “Yes”) requires a selection from the user indicating whether expansion of the value for the field is permitted as part of the effort to return the desired number of results. For example, the user has indicated that modification of the value for the Gender field is not permitted. In contrast, the user has indicated that modification is permitted for the values of the Result field and the Postal Code field. It is contemplated that the selection is made by the user through a graphical user interface, e.g., the user interface 122 shown in FIG. 1. Examples of user interfaces configured for abstract query building which may be enhanced with value modification selection are described in commonly known U.S. patent application Ser. No. 10/094,531, entitled “GRAPHICAL USER INTERFACE TO BUILD EVENT BASED DYNAMIC SEARCHES OR QUERIES USING EVENT PROFILES” herein incorporated by reference. Although not shown, it is contemplated that the user interfaces may permit the user to make any variety of selections to facilitate result management. For example, in addition to specifying the desired result size range and selecting which logical field values may be modified to achieve the range, the user may be allowed to select a number of queries to be returned, each of which satisfy the desired result size range. For convenience, the user selectable criteria to specifying the result size range and/or the number of queries to be returned which satisfy the desired result size range are referred to herein as results criteria. Persons skilled in the art will recognize other options and selections which may be made available to the user through a user interface.

Referring now to FIG. 5, a flowchart is shown illustrating a method 500 for query modification and execution of the basis of result criteria and field expansion enabled by attributes of the data abstraction model. In one embodiment, the method 500 is implemented by the analysis tool 162 of the run-time component 150. The method 500 is entered when an initial abstract query is received (step 502). The run-time component 150 then builds query elements which may be used to modify the initial abstract query (step 504). The run-time component 150 then runs the initial abstract query (step 506). Embodiments for running the abstract query have been described above with reference to FIGS. 3 and 4. Once the results are returned for the initial abstract query, the run-time component 150 determines whether the user specified results criteria are satisfied (step 508). With respect to the illustrative abstract query provided above, step 508 is a determination of whether the number of results is between 100 and 500. In other cases, the user may also have specified a number of queries to be returned, each of which satisfies the result size range specification. In any case, if the results criteria are satisfied, the method 500 is complete. However, if the results criteria are not satisfied, the run-time component 150 modifies the initial abstract query using the query elements generated step 504. The modified query is then run (step 506). This process is repeated iteratively until the results criteria is satisfied.

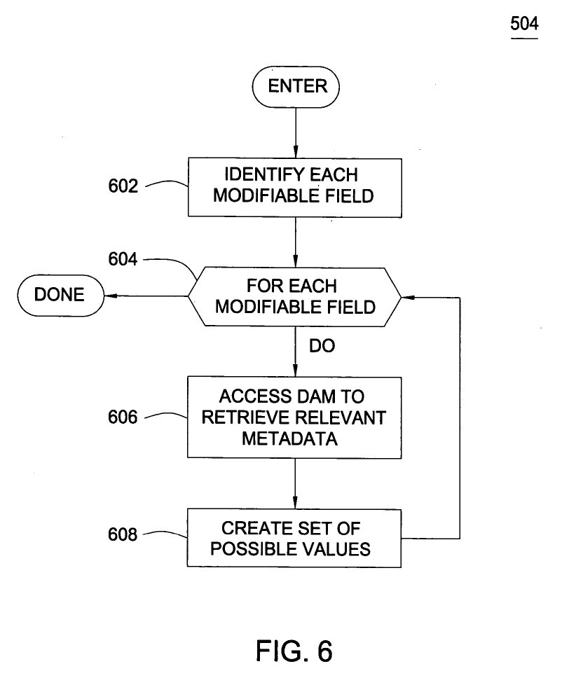

Referring now to FIG. 6 a flowchart is shown illustrating one embodiment of step 504 in which the run-time component builds query elements for subsequent use in producing modified queries. In particular, the run-time component 150 first identifies each modifiable field in the abstract query (step 602). That is, the run-time component 150 identifies those fields in the abstract query the values of which the user has specified may be modifiable in an effort to satisfy the result criteria (e.g., the Result field and the Postal Code field in the illustrative abstract query above). For each modifiable field (loop entered at step 604), the run-time component 150 refers to the data abstraction model 148 (step 606) to determine any specifications on the modification that can be made to the corresponding value (e.g., the type of value modification permitted, any limitations on the modification, any spatial extenders to be used, etc). Based on the metadata in the data abstraction model, as well as any relevant data supplied in the abstract query (e.g., the expansion level), the run-time component 150 then creates a set of possible values for each of the logical fields (step 608). Once each expandable field has been processed, processing proceeds to step 506 of FIG. 5 where the initial abstract query is run.

As an example, Table IV shows illustrative possible values for the exemplary query shown above.

TABLE IV

Gender
Female (Initial query value)
Result
Result > 70
Result > 80
Result > 90
Result > 100 (Initial query value)
Result > 110
Result > 120
Result > 130
PostalCode
PostalCode IN { DB2SpatialExtender.java(‘55901’, 50) }
PostalCode IN { DB2SpatialExtender.java(‘55901’, 40) }
PostalCode IN { DB2SpatialExtender.java(‘55901’, 30) }
PostalCode IN { DB2SpatialExtender.java(‘55901’, 20) }
PostalCode IN { DB2SpatialExtender.java(‘55901’, 10) }
PostalCode = ‘55901’ (Initial query value)

Note that in Table IV only one value is available for Gender, since the user specified that the value for Gender must be Female. In the case of the Result field an infinite number of values are possible since Result is defined as a floating point. By way of illustration only, a possible subset of values is shown. The subset illustrates that the possible values may be less than or greater than the original value of 100. Note that the user specified expansion level of 30 (in the abstract query) limits the set of possibilities to a minimum of 70 and a maximum of 130. In the case of the Postal Code, the DB2 spatial extender is relied upon to increase the geographic area of inclusion beyond the specified zip code in increments of 10 miles up to the user specified expansion level of 50 miles.

It is noted that in one embodiment, the processing performed in step 504 is not performed until after the initial abstract query is run. This approach is more efficient in the simplified situation where the results of the initial abstract query satisfy all of the results criteria and no further processing is needed. However, it is also contemplated that an optimization algorithm is applied to the initial query vis-à-vis the query elements which may result in the generation and execution of a modified query (i.e., the initial query with modified field values) before execution of the initial query. That is, the optimization algorithm may determine that a modified query is more likely to return results that satisfy the result criteria and, therefore, forgo executing the initial query.

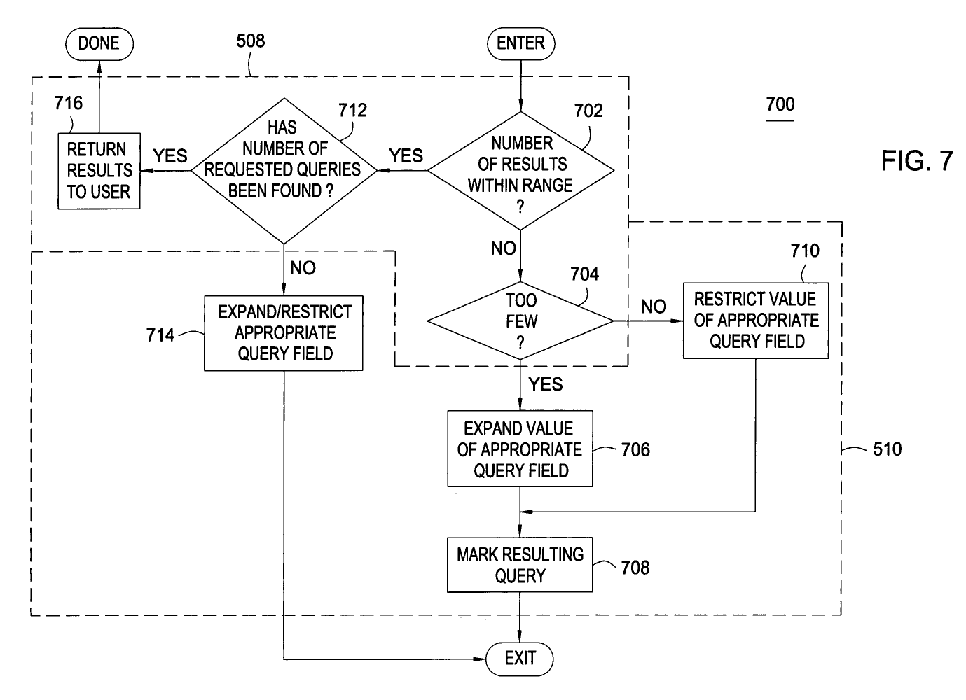

Referring now to FIG. 7 a method 700 illustrating embodiments of step 508 (determining whether the user results criteria are satisfied) and step 510 (modifying the query) is shown. After a query is run, the run-time component 150 determines whether the number of results of the query are within the specified range (step 702). Using the illustrative abstract query above as an example, the run-time component 150 determines whether the number of results is between 100 and 500. If not, the results are either too many or too few (a determination made by the run-time component at step 704). If the results are too few, a value of an appropriate field of the query is expanded (step 706). If the results are too many, a value of an appropriate field of the query is restricted (step 710). The resulting query may then be marked (step 708), or preserved in some fashion, to ensure that it is not executed more than once (for a given initial abstract query). Processing then proceeds to step 506 (FIG. 5) where the modified query is run.

In one embodiment, an “appropriate” field (steps 706 and 710) is determined according to a weighting system. Is contemplated that the weighting system could be customizable either by an administrator or end-user. As an example, it is expected that the removal of a condition from a query is much more damaging to the user's intent than is a small range widening. Consider, for example, a user looking for males between the age of 40 and 45. The user is likely to prefer results from males between 38 and 47 than males and females between 40 and 45. Accordingly, a weighting system may place a higher weight on modifying the age value, rather than removing the gender condition. If no weights are assigned, the run-time component 150 may simply alternate between fields that are expandable. In a different embodiment, a more sophisticated selection algorithm (e.g., statistical algorithm) may be implemented to select the order in which (or even whether) fields are changed. Persons skilled in the art will recognize a variety of other embodiments all within the scope of the invention. In addition to assigning weights to establish a priority of changing one field before or after another, weights may be assigned to facilitate a determination of how aggressively or conservatively to expand or restrict a given range.

Instead of (or in addition to) assigned weights, other criteria may be taken into account in determining which values to modify. For example, expansion or restriction may not be possible for a given value if the specified expansion level has been achieved (e.g., 30 in the case of the Result field for the above abstract query). Further, once a given value is selected for expansion or restriction, it is contemplated that statistical sampling, cardinality of different values, previous result set sizes, etc., may be used to intelligently determine the amount of modification (e.g., restriction or expansion) of the given value.

If, however, the number of results for a given query are within the specified range (determined at step 702), the run-time component 150 determines whether the number of requested queries has been found (step 712). That is, the user may have specified that N queries are to be returned, each of which satisfy the result set size criteria (e.g., 100 to 500 in the present example). If step 712 is answered in the negative, the run-time component 150 then take steps to expand or restrict an appropriate field (step 714), as defined above, and then runs the modified query (at step 506 of FIG. 5). If step 712 is answered in the affirmative, the processing with respect to the given initial query is complete and all requested results are returned to the user (step 716).

Of course, any number of other steps may be performed in other embodiments. For example, it is contemplated that the user may be presented with N number of modified queries, each of which satisfy the result set size criteria. The user may then select one or more of the modified queries and be presented with results for each of the selected queries.

While the foregoing is directed to embodiments of the present invention, other and further embodiments of the invention may be devised without departing from the basic scope thereof, and the scope thereof is determined by the claims that follow.

1. A computer-implemented method of using a logical model to query physical fields of physical data entities, comprising:
providing a logical model to logically describe the physical fields, the logical model comprising logical fields corresponding to respective physical fields; and
providing a runtime component configured to change at least one element of an abstract query in an attempt to produce a modified abstract query which, when executed, returns results satisfying a result set criterion; wherein the abstract query is defined with respect to at least one logical field of the logical model and wherein at least one value is specified for the at least one logical field.

2. The method of claim 1, wherein the element is the value and further comprising changing, by the runtime component, the at least one value by increasing or decreasing the value.

3. The method of claim 1, further comprising changing, by the runtime component, the at least one element by removing the element from the abstract query.

4. The method of claim 1, further comprising changing, by the runtime component, the at least one element with respect to a weight assigned to the element, the weight indicating a relative priority of changing the element relative to other elements in the abstract query.

5. The method of claim 1, wherein the at least one logical field of the logical model has an associated element modification parameter defining a parameter for changing, by the runtime component, the at least one element.

6. The method of claim 1, wherein the at least one logical field of the logical model has an associated element modification attribute indicating that the element specified in the abstract query for the at least one logical field may be modified by the runtime component.

7. The method of claim 1, wherein the at least one element is user-defined.

8. The method of claim 1, wherein the abstract query, including the result set criterion, is user-defined.

9. The method of claim 1, wherein the physical data entities comprise a plurality of tables in a database.

10. The method of claim 1, wherein the associated result set criterion is part of the abstract query.

11. The method of claim 1, further comprising transforming, by the runtime component, and with reference to the logical model, the abstract query into a form consistent with the physical data entities.

12. A computer-implemented method of returning a desired result set for a query, comprising:
providing a logical model to logically describe physical fields of physical data entities, the logical model comprising logical fields corresponding to respective physical fields and each having an associated modification parameter;
receiving an abstract query comprising a result set criterion and selection criterion comprising at least one of the logical fields of the logical model; and
manipulating the abstract query in an attempt to produce a modified abstract query which, when executed, returns results satisfying the result set criterion; wherein the manipulating is, at least in part, defined by the modification parameter associated with the at least one of the logical fields of the selection criterion.

13. The method of claim 12, further comprising iteratively performing the manipulating until the results are returned satisfying the result set criterion.

14. The method of claim 12, wherein the result set criterion comprises a result set size specification.

15. The method of claim 12, wherein the selection criterion comprises a specified value for the at least one of the logical fields of the selection criterion and wherein manipulating the abstract query comprises manipulating the specified value.

16. The method of claim 15, wherein manipulating the value comprises at least one of:
increasing the value;
decreasing the value; and
removing the value from the query.

17. The method of claim 15, wherein manipulating the value comprises at least one of:
removing a condition from the query;
adding a condition to the query; and
changing a condition with the query.

18. The method of claim 12, wherein manipulating the abstract query is done with respect to a weight assigned to an element of the abstract query, the weight indicating a relative priority of changing the element relative to other elements in the abstract query.

19. A computer-implemented method of building queries, comprising:
providing a logical model to logically describe physical fields of a plurality of physical data entities, the logical model comprising logical fields corresponding to respective physical fields;
receiving an abstract query defined with respect to at least one logical field of the logical model and comprising a user-specified value for the at least one logical field and a result set criterion specifying at least a size of a desired result set; and
programmatically manipulating an element of the abstract query in an attempt to produce a modified abstract query which, when executed, returns results satisfying the result set criterion.

20. The method of claim 19, further comprising transforming, with reference to the logical model, the modified abstract query into a form consistent with the data.

21. The method of claim 19, wherein the at least one logical field has an associated value modification parameter defined in the logical model and wherein the manipulating comprises manipulating the user-specified value in a manner limited by the associated value modification parameter.

22. The method of claim 19, wherein the manipulating is performed iteratively until producing the modified query which, when executed, returns results satisfying the result set criterion.

23. The method of claim 19, wherein manipulating the element comprises at least one of:
increasing the value;
decreasing the value; and
removing the value from the abstract query.

24. The method of claim 19, wherein manipulating the element comprises at least one of:
removing a condition from the abstract query;
adding a condition to the abstract query; and
changing a condition with the abstract query.

25. The method of claim 19, wherein manipulating the element is done with respect to a weight assigned to the element, the weight indicating a relative priority of changing the element relative to other elements in the abstract query.

26. A computer-implemented method for returning a specified result size set for a query, comprising:
(a) receiving a query comprising at least one condition, an associated value for the condition and a user-specified results criterion;
(b) changing a first element of the query to produce a modified query;
(c) running the modified query to produce a result set;
(d) if the result set does not satisfy the user-specified results criterion, changing one of the first element and a second element to produce a different modified query; and
(e) running the different modified query to produce a different result set.

27. The method of claim 26, wherein changing either of the first element and the second element comprises at least one of:
increasing the associated value;
decreasing the associated value; and
removing the associated value from the query.

28. The method of claim 26, wherein changing either of the first element and the second element comprises at least one of:
adding a condition to the query;
removing the at least one condition from the query; and
changing the at least one condition with the query.

29. The method of claim 26, wherein changing either of the first element and the second element is done with respect to a weight assigned to the element, the weight indicating a relative priority of changing the element relative to other elements in the abstract query.

30. The method of claim 26, further comprising repeating (d) and (e) until the result set satisfies the result criterion.

31. The method of claim 26, wherein the result criterion is a result set size criterion.

32. The method of claim 26, wherein the result criterion specifies a number of queries to be generated by changing the first or second element, wherein each generated query produces a result set size specified by the result criterion.

33. A computer readable medium containing a program which, when executed, performs an operation with respect to abstract queries and a logical model comprising a plurality of logical field definitions mapping to physical fields of physical entities of the data, the operation comprising:
receiving an abstract query defined with respect to at least one logical field of the logical model and comprising (i) a user-specified value for the at least one logical field and (ii) a result set criterion specifying at least a size of a desired result set; and
manipulating the abstract query in an attempt to produce a modified abstract query which, when executed, returns results satisfying the result set criterion.

34. The computer readable medium of claim 33, wherein the abstract query comprises a limitation parameter limiting the manipulating of the element.

35. The computer readable medium of claim 33, wherein the manipulating is performed iteratively until producing the modified query which, when executed, returns results satisfying the result set criterion.

36. The computer readable medium of claim 33, wherein the at least one logical field has an associated element modification parameter defined in the logical model and wherein the manipulating is limited by the associated element modification parameter.

37. The computer readable medium of claim 33, wherein manipulating the element comprises at least one of:
increasing the value;
decreasing the value; and
removing the value from the query.

38. The computer readable medium of claim 33, wherein manipulating the element comprises at least one of:
removing a condition from the query;
adding a condition to the query; and
changing a condition with the query.

39. The computer readable medium of claim 33, wherein the manipulating is performed with respect to a weight assigned to the element, the weight indicating a relative priority of manipulating the element relative to other elements in the abstract query.

40. The computer readable medium of claim 33, wherein the physical data entities comprise a plurality of tables in a database.

41. The computer readable medium of claim 33, further comprising transforming, with reference to the logical model, the modified abstract query into a form consistent with the data.

42. A computer system, comprising memory and at least one processor, and further comprising:
a logical model comprising a plurality of logical field definitions mapping to physical fields of physical entities of data, whereby the logical model provides a logical view of the data; and
a runtime component configured to at least (i) receive an abstract query comprising at least one condition with a reference to at least one of the logical field definitions, a value for the at least one logical field and at least one user-selected result size criterion specifying a desired result set size to be returned; and (ii) change an element of the abstract query in an effort to satisfy the result size criterion.

43. The system of claim 42, wherein the at least one of the logical field definitions comprises an attribute indicating that the element may be changed.

44. The system of claim 42, wherein the abstract query further comprises a limitation on an extent of permitted change to the element.

45. The system of claim 42, wherein the element is a value and wherein the abstract query further comprises a plurality of values, each for a different logical field definitions, and wherein the runtime component is configured to change each of the values to produce different permutations of the abstract query in an effort to satisfy the result size criterion.
